(19) United States
(12) Patent Application Publication
(10) Pub. No.: US 2006/0289271 A1
(43) Pub. Date: Dec. 28, 2006

(54) FIREWOOD DELIVERY APPARATUS

(76) Inventor: Jonathan M. Nelson, Blair, NE (US)

Correspondence Address: BLACKWELL SANDERS PEPER MARTIN, LLP, 1620 DODGE STREET, SUITE 2100, OMAHA, NE, 68102, US

(21) Appl. No.: 11/421,215

(22) Filed: May 31, 2006

Related U.S. Application Data
(60) Provisional application No. 60/686,260, filed on Jun. 1, 2005.

(51) Int. Cl. B65G 37/00; B65G 1/00

(52) U.S. Cl. 198/347.1

(57) ABSTRACT

A firewood delivery apparatus comprising a platform mounted on a plurality of cross-support members coupled to one or more roller mechanisms, a base upon which each roller mechanism is supported, an apron for connecting the platform and base, wherein the apron encloses a cavity formed between the platform and the base, a frame for coupling with the apron; and a divider mounted to the frame and the platform. The platform and cross-support members rotate along a circumference measuring up to and including 360 degrees.

### CROSS REFERENCE TO RELATED APPLICATION

This application claims the benefit of U.S. provisional application Ser. No. 60/686,260, filed Jun. 1, 2005 the disclosure of which is incorporated herein by reference.

### FIELD OF THE INVENTION

The present invention generally relates to the field of household fixtures, and more particularly to an apparatus for delivering firewood.

### BACKGROUND OF THE INVENTION

Currently, a number of residences, lodges, cabins and the like are equipped with wood-burning fireplaces. Although such fireplaces are popular due to the old-time charm and comfort they provide, the process of storing and obtaining firewood for use with these fireplaces can be an inconvenience. For example, a user wanting to build a fire may have to go outdoors to obtain firewood, such as to a remotely-located woodpile on the user's property. This can be especially inconvenient when weather conditions are poor. Further, the user then has to carry or transport the firewood from the remotely-located woodpile to the fireplace. During transport, debris from the firewood may become scattered throughout the user's home, such as when the user is carrying the firewood across a family room where the fireplace is located. In order to avoid a separate trip outside to a remotely-located woodpile each time the user wants to build a fire, some users will opt to store a small amount of firewood indoors. For example, a user may store firewood in a firewood rack located in proximity to the fireplace. This can also be a problem because storing firewood indoors that has been brought in from an outdoor location may result in unwanted insects or pests being brought into the user's home.

Accordingly, it would be desirable to provide a firewood delivery apparatus, which allows a user easy access to firewood, without having to go outdoors to obtain it and without having to store any firewood indoors.

### SUMMARY OF THE INVENTION

A firewood delivery apparatus comprising a platform mounted on a plurality of cross-support members coupled to one or more roller mechanisms, a base upon which each roller mechanism is supported, an apron for connecting the platform and base, wherein the apron encloses a cavity formed between the platform and the base, a frame for coupling with the apron; and a divider mounted to the frame and the platform. The platform and cross-support members rotate along a circumference measuring up to and including 360 degrees.

### BRIEF DESCRIPTION OF THE DRAWINGS

The numerous objects and advantages of the present invention may be better understood by those skilled in the art by reference to the accompanying figures in which:

FIGS. 1-11 are illustrations of a firewood delivery apparatus in accordance with exemplary embodiments of the present invention.

### DETAILED DESCRIPTION OF THE INVENTION

Reference will now be made in detail to the presently preferred embodiments of the invention, examples of which are illustrated in the accompanying drawings.

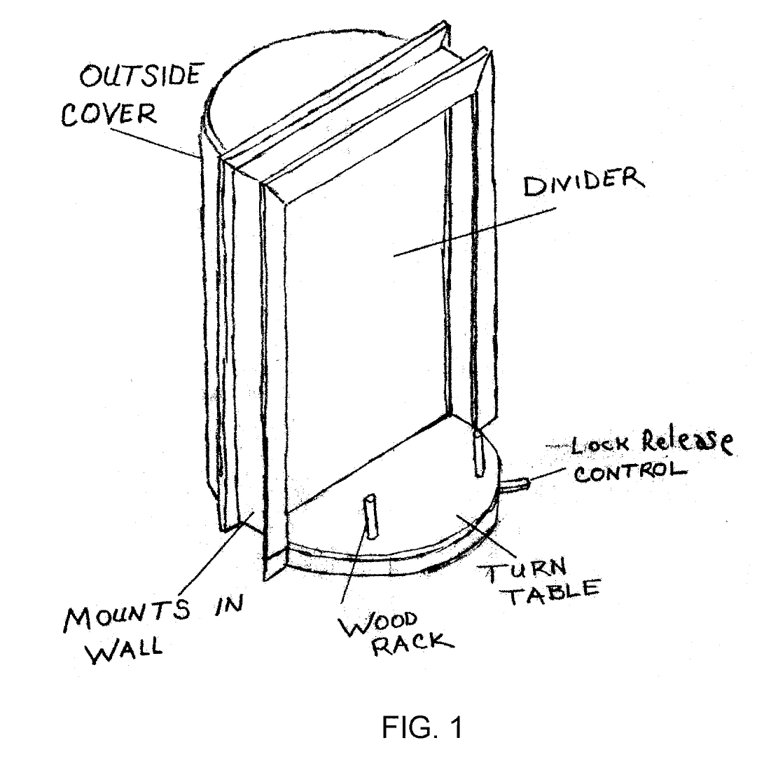

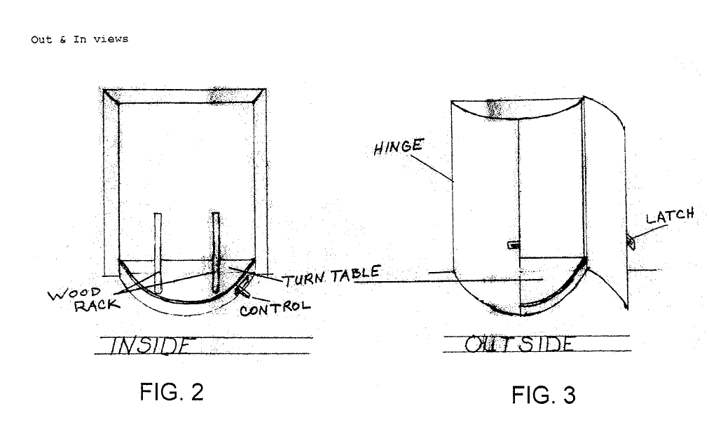

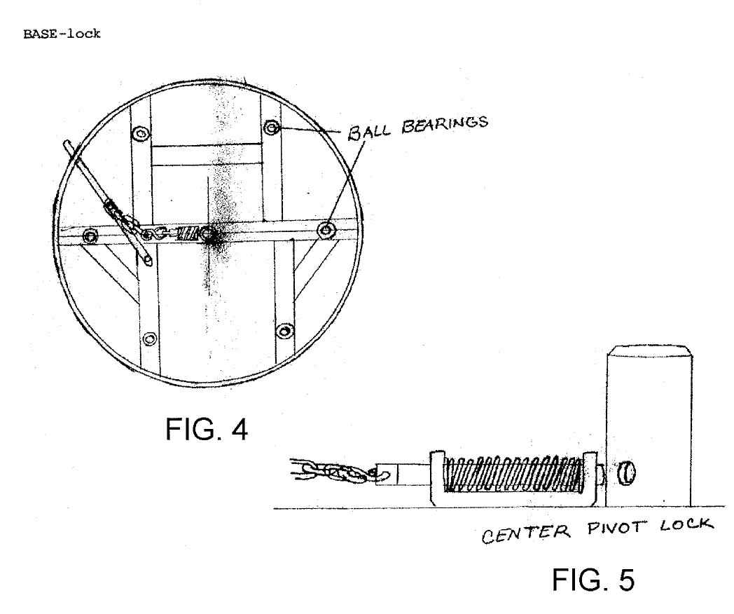

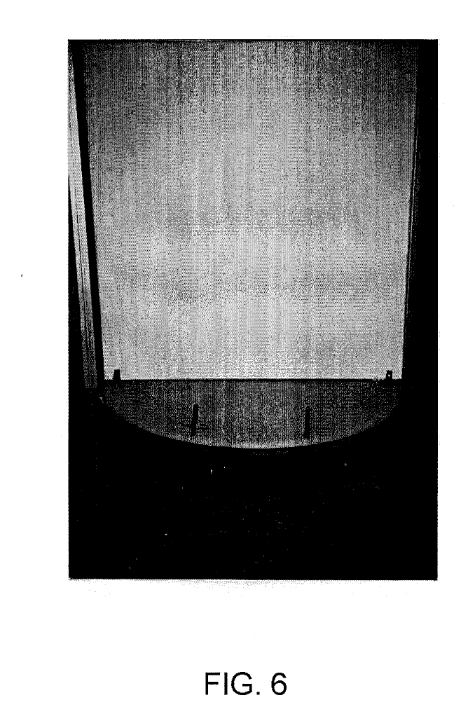

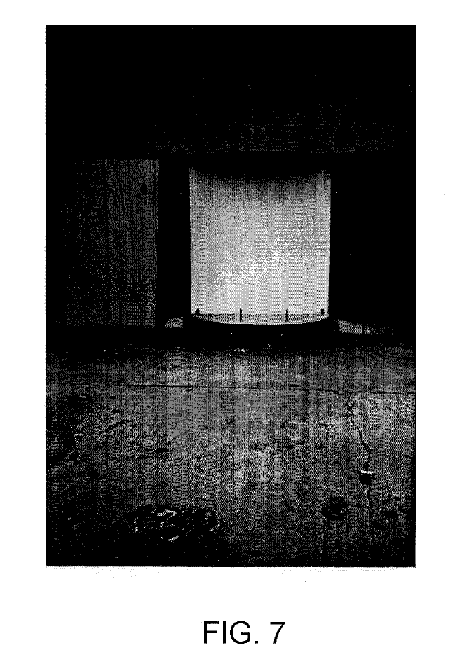

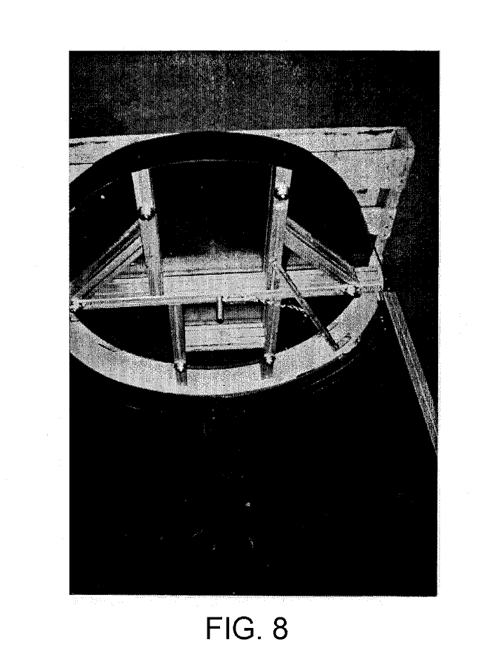

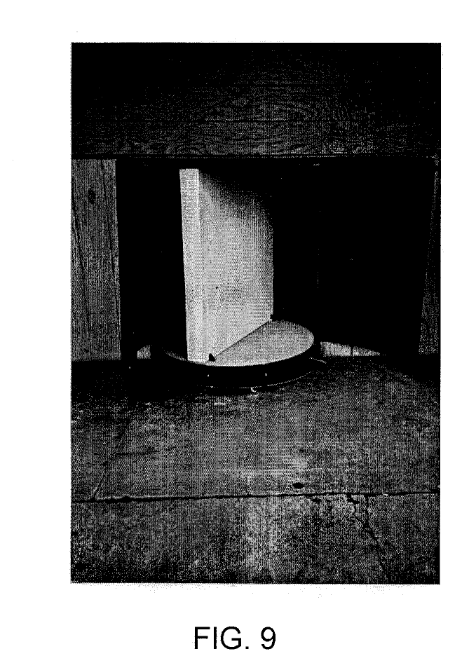

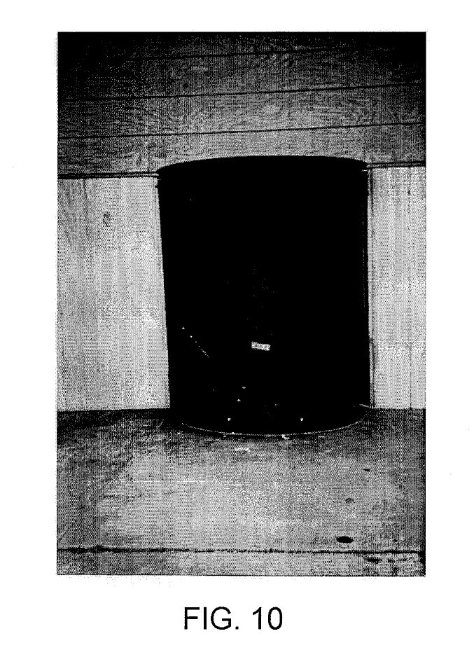

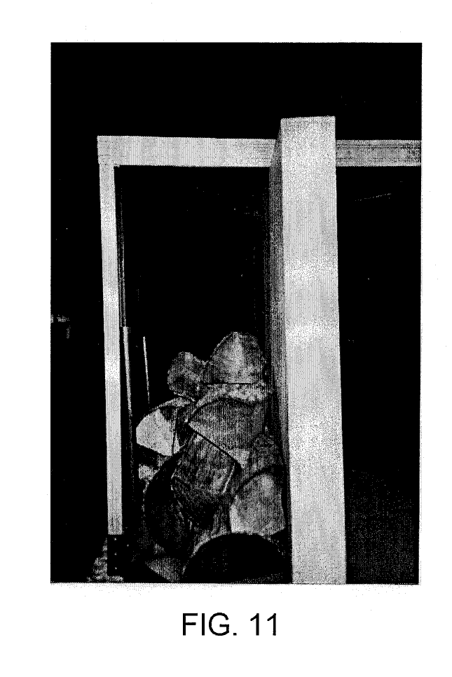

Referring now to FIGS. 1 through 11, a firewood delivery apparatus is disclosed. The firewood delivery apparatus includes a platform, such as a generally disc-shaped platform, suitable for supporting firewood. The platform is further mounted upon a plurality of cross-support members, for instance, a plurality of rectilinearly-shaped steel bars, for stabilizing the platform. One or more of the plurality of cross-support members is further coupled to one or more roller mechanisms, which enable the platform to rotate with the cross-support members about a centrally-located axis with respect to the platform, the axis extending in a vertical plane perpendicular to the platform. The platform and cross-support members may rotate along a circumference measuring up to and including 360 degrees. The apparatus further includes a base, such as a generally disc-shaped base having dimensions generally similar to the platform, upon which each roller mechanism is supported. The apparatus further includes an apron for connecting the platform and base, the apron further enclosing a cavity formed between the platform and base. The apron, which aligns and defines the circumference of the platform and base, extends in a vertical direction perpendicular to the platform. In a present embodiment, the apron extends beyond an upper surface of the platform for providing a barrier for retaining firewood upon the platform.

The apparatus further includes a frame, such as an inverted, U-shaped frame, for coupling with the apron. The apron forms a plurality of receivers, each configured for receiving a portion of the frame for coupling the frame with the apron.

The firewood delivery apparatus further includes a divider mounted to the frame and the platform. In an exemplary embodiment, the divider is a generally rectangular-shaped piece of plywood which is mounted on the platform so that approximately half of the platform is positioned on each side of the divider. A first end of the divider is mounted on the platform via a lower rotating clamp, which protrudes through a centrally-located aperture formed by the platform. In further embodiments, one or more mounting brackets may be included for mounting the divider upon the platform. The divider is connected on an end opposite the first end with the frame, via an upper rotating clamp. The upper rotating clamp may be coupled with the frame and axially aligned with the lower rotating clamp. In current embodiments, as the platform and cross-support members rotate, the divider, upper rotating clamp and lower rotating clamp also rotate with the platform and cross-support members.

In an exemplary embodiment, the rotational capability of the platform may be selectively enabled by a user. For example, the apron may form an aperture through which a device for selectively causing rotation of the platform protrudes, such as a handle, lever, switch, pedal or the like. In current embodiments, the device is mechanically engaged, such as by a spring-biased locking pin, with the lower rotating clamp for selectively unlocking/locking the lower rotating clamp, thereby selectively enabling/disabling rotation of the platform. In further embodiments, a motorized system for selectively enabling/disabling rotation of the platform may be included.

In a present embodiment, portions of the divider are positioned within the upper and lower rotating clamps. The divider, upper rotating clamp and lower rotating clamp move in unison with the platform as the platform rotates. The frame of the firewood delivery apparatus may be mounted within a wall in such a manner that half of the platform is positioned on an exterior side of the wall, the other half of the platform being positioned on an interior side of the wall, the divider separating the two halves of the platform. For instance, the apparatus may be mounted or set within a wall of a family room of a house, proximal to a wood-burning fireplace. On the half of the platform positioned on the exterior side of the wall (i.e. —on the outside of a user's house), firewood may be placed. The half of the platform positioned on the interior side of the wall (i.e. —the half positioned within the family room) has no firewood placed upon it. The frame may be configured with weather stripping, such as black rubber weather stripping, along its perimeter for providing a seal between the divider and the frame and/or the frame and the wall to assist in providing a barrier to the elements (i.e. —wind, rain, etc.). Further, when a user wants to obtain firewood, he or she can cause the platform to rotate so that the half of the platform initially oriented on the exterior side of the wall is positioned on the interior side of the wall, thereby allowing the user to access the firewood. After obtaining a desired amount of firewood, the user can rotate the platform so that the half containing the firewood is once again returned to its original position on the exterior side of the wall. This provides a way for a user to obtain firewood without having to leave his or her family room and without having to store the firewood inside of his or her home.

In further embodiments, the firewood delivery apparatus includes one or more doors for providing an enclosure for firewood stored on the platform. Preferably, the one or more doors are coupled with the frame, such as by one or more hinges, and are positioned for enclosing half of the platform. For example, the doors may enclose the half of the platform positioned on an exterior side of a wall. The doors may further be configured with a latch or locking mechanism for locking the doors, such as to prevent access by others outdoors to firewood stored on the platform. In further embodiments, the doors may be screened or include one or more viewing ports for providing a user a visual indication as to whether or not any firewood is stored on the platform.

In further embodiments, the firewood delivery apparatus may include a barometer. In additional embodiments, the firewood delivery apparatus includes a thermometer. In exemplary embodiments, one or more edges of the divider may be rounded off or beveled. In further embodiments, the apparatus may be equipped with a lighting system.

It is believed that the firewood delivery apparatus of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof.

What is claimed is:

1. A firewood delivery apparatus comprising:
(i) a platform mounted on a plurality of cross-support members coupled to one or more roller mechanisms;
(ii) a base upon which each roller mechanism is supported;
(iii) an apron for connecting the platform and base, wherein the apron encloses a cavity formed between the platform and the base;
(iv) a frame for coupling with the apron; and
(v) a divider mounted to the frame and the platform;
wherein the platform and cross-support members rotate along a circumference measuring up to and including 360 degrees.

2. The apparatus of claim 1, wherein the platform is disc-shaped.

3. The apparatus of claim 1, wherein the platform is suitable for supporting firewood.

4. The apparatus of claim 1, wherein the plurality of cross-support members comprise a plurality of rectilinearly-shaped steel bars for stabilizing the platform.

5. The apparatus of claim 1, wherein the one or more roller mechanism enable the platform to rotate with cross-support members about a centrally-located axis with respect to the platform.

6. The apparatus of claim 5, wherein the centrally-located axis extends in a vertical plane perpendicular to the platform.

7. The apparatus of claim 1, wherein the base is disc-shaped.

8. The apparatus of claim 1, wherein the bases comprises dimensions generally similar to the platform.

9. The apparatus of claim 1, wherein the apron aligns and defines the circumference of the platform and the base.

10. The apparatus of claim 9, wherein the apron extends in a vertical direction perpendicular to the platform.

11. The apparatus of claim 1, wherein the apron extends beyond an upper surface of the platform.

12. The apparatus of claim 11, wherein the apron provides a barrier for retaining firewood upon the platform.

13. The apparatus of claim 1, wherein the frame comprises an inverted, U-shaped frame.

14. The apparatus of claim 1, wherein the apron forms a plurality of receivers, each configured for receiving a portion of the frame for coupling the frame with the apron.

15. The apparatus of claim 1, wherein the divider comprises a rectangular-shaped piece of plywood which is mounted on the platform.

16. The apparatus of claim 15, wherein approximately half of the platform is positioned on each side of the divider.

17. The apparatus of claim 1, further comprising a first end of the divider mounted on the platform via a lower rotating clamp which protrudes through a centrally-located aperture formed by the platform.

18. The apparatus of claim 1, wherein one or more mounting brackets are included for mounting the divider upon the platform.

19. The apparatus of claim 17, wherein the divider is connected to an end opposite the first end with the frame, via an upper rotating clamp.

20. The apparatus of claim 19, wherein the upper rotating clamp is coupled with the frame and axially aligned with the lower rotating clamp.

21. A firewood delivery apparatus comprising:
(i) a platform mounted on a plurality of cross-support members coupled to one or more roller mechanisms which enable the platform to rotate with the cross-support members about a centrally-located axis with respect to the platform, wherein the platform is suitable for supporting firewood;
(ii) a base upon which each roller mechanism is supported;
(iii) an apron for connecting the platform and base, wherein the apron encloses a cavity formed between the platform and the base;
(iv) a frame for coupling with the apron; and
(v) a divider mounted to the frame and the platform, wherein a first end of the divider is mounted on the platform via a lower rotating clamp which protrudes through a centrally-located aperture formed by the platform and the divider is connected to an end opposite the first end with the frame via an upper rotating clamp, wherein the upper rotating clamp is coupled with the frame and axially aligned with the lower rotating clamp;
wherein the platform and cross-support members rotate along a circumference measuring up to and including 360 degrees;
wherein, as the platform and cross-support members rotate, the divider, upper rotating clamp and lower rotating clamp also rotate with the platform and cross-support members.
